(19) United States
(12) Patent Application Publication
(10) Pub. No.: US 2024/0068707 A1
(43) Pub. Date: Feb. 29, 2024

(54) Serviceable Condensate Neutralizing Exhaust Tee For High Efficiency Gas Storage Water Heaters

(71) Applicant: Rheem Manufacturing Company, Atlanta, GA (US)

(72) Inventors: Jeremy Allan Peters, Coosada, AL (US); Martin John Fabian, Dadeville, AL (US); Madhuresh Bhandari, Montgomery, AL (US); Matthew A. Jackson, Prattville, AL (US); Prudhvi Vishnu Vardhan Amaravadhi, Pike Road, AL (US)

(21) Appl. No.: 18/458,865

(22) Filed: Aug. 30, 2023

Related U.S. Application Data
(60) Provisional application No. 63/402,798, filed on Aug. 31, 2022.

(51) Int. Cl. F24H 8/00; B01D 53/40; F24H 1/18

(52) U.S. Cl. CPC F24H 8/006; B01D 53/40; F24H 1/186; F24H 2220/00

(57) ABSTRACT

An exhaust conduit for neutralizing condensate from high efficiency gas storage water heaters is provided. The exhaust conduit includes an inlet configured to be coupled to an exhaust outlet of the heater, an outlet configured to be coupled to an exhaust vent, and a condensate chamber having an interior in fluidic communication with the inlet and the outlet. The condensate chamber has a lower portion configured to receive a neutralizer and an upper portion having a service port configured to provide access to the lower portion of the condensate chamber. The condensate chamber further includes a fluid outlet for draining the neutralized condensate via a drain line. The exhaust conduit has one or more ridges disposed in the chamber that are arranged to define a channel for directing condensate from the inlet across the neutralizer toward the fluid outlet.

### CROSS-REFERENCE TO RELATED APPLICATION

This application claims the benefit of U.S. application Ser. No. 63/402,798, filed Aug. 31, 2022, the entirety of which is hereby incorporated by reference.

### TECHNICAL FIELD

The present disclosure is generally in the field of high efficiency gas storage water heaters and more particularly an exhaust tee for neutralizing condensate from the water heater.

### BACKGROUND

Most residential and commercial heating and hot water systems include a furnace, boiler, or domestic water heater of the high efficiency condensing type. High-efficiency condensing-type appliances extract additional heat from the water vapor in the flue gas. As a result, the flue gas drops below its dew point and vapor present in the flue gas starts to condense. Condensation of flue gas produces an acidic solution typically containing nitric, nitrous, sulfuric, sulfurous and hydrochloric acids, which are produced from the nitrogen oxides, sulfur oxides and hydrogen chloride present in natural gas.

Most state and local codes prohibit introducing acidic liquid into a drainage system. Acidic condensate can damage piping systems, sewerage systems, treatment facilities, septic systems and other items with which it may come in contact. Neutralization of the acidic condensate is required to avoid damage and to comply with the state and local codes. Presently, it is the responsibility of the plumbing professional to install a cartridge or other vessel containing a neutralizing agent at a point in the drain line to follow state and local plumbing codes.

There are several disadvantages with current designs. For example, there is a chance the neutralizing cartridge is never installed putting the piping system at risk. Many purchasers of high efficiency appliances may not be aware of this additional step to confirm the cartridge has actually been installed. Also, depending on the volume of condensation, such vessels can be unsightly or awkward to incorporate into the space provided for the appliance.

The foregoing background information is provided to reveal information believed by the applicant to be of possible relevance to the present disclosure. No admission is necessarily intended, nor should be construed, that any of the preceding information constitutes prior art against the present disclosure.

### BRIEF DESCRIPTION OF THE DRAWINGS

FIG. 1A illustrates an exemplary gas storage water heater system constructed in accordance with the principles of the present disclosure.

FIGS. 2A and 2B are perspective views of an exemplary exhaust tee constructed in accordance with the principles of the present disclosure.

FIG. 2C is an exploded view of the exhaust tee of FIGS. 2A and 2B.

FIG. 3 is an interior view of the lower portion of the exhaust tee, constructed in accordance with the principles of the present disclosure.

FIG. 4 is an interior view of the upper portion of the exhaust tee, constructed in accordance with the principles of the present disclosure.

FIG. 5A is cross-sectional view of the exhaust tee, and FIG. 5B is a close-up view of the fluid outlet of FIG. 5A.

### DETAILED DESCRIPTION

The present disclosure is directed to an exhaust conduit, e.g., an exhaust tee, that can form part of an exhaust duct of, e.g., a gas storage water heater, and that has a chamber to facilitate the pooling of condensate formed as flue gas cools within the exhaust duct. The exhaust tee includes a fluid outlet configured to couple with a drain line for draining the pooled condensate, and is configured so that exhaust gas does not exit through the fluid outlet. The chamber of the exhaust tee is sized and shaped to hold a neutralizing agent to neutralize acidic condensate pooled therein. Moreover, the exhaust tee includes upwardly extending ridges within the chamber that define a channel to guide condensate formed in the exhaust tee through the neutralizing agent within the chamber and towards the fluid outlet.

High input units require a larger exhaust tee for pressure relief and such heaters are commonly vented with 4″ venting. Accordingly, the exhaust conduits described herein may be configured to accommodate at least 4″ venting. As will be understood by a person having ordinary skill in the art, the exhaust conduit may accommodate smaller venting, e.g., 3″ venting or smaller. The exhaust conduits described herein make replacement easier for the installer and neutralizes the condensate before leaving the heater instead of having to add a kit to the condensate line which could leak. Moreover, the exhaust conduits described herein allow for easier servicing of neutralizer over current methods that require removing the venting to access the exhaust tee.

Some representative embodiments will be described more fully hereinafter with example reference to the accompanying drawings that illustrate embodiments of the invention. Embodiments may take many different forms and should not be construed as limited to the embodiments set forth herein; rather, these embodiments are provided so that this disclosure will be thorough and complete, and will fully convey the scope of the invention to those appropriately skilled in the art.

In accordance with some aspects of the present invention, a gas storage water heater having an exhaust outlet configured to be coupled to an exhaust conduit is provided. The exhaust conduit is configured for neutralizing condensate in exhaust gas from the gas storage water heater having the exhaust outlet as the exhaust gas is expelled via an exhaust vent. The exhaust conduit may include an inlet configured to be coupled to the exhaust outlet, an outlet configured to be coupled to the exhaust vent, and a condensate chamber having an interior in fluidic communication with the inlet and the outlet. The condensate chamber includes a lower portion configured to receive a neutralizer and an upper portion having a service port configured to provide access to the lower portion of the condensate chamber in an open state. The exhaust conduit further may include a fluid outlet in fluidic communication with the condensate chamber, and one or more ridges disposed in the chamber. The one or more ridges may be arranged to define a channel configured to direct condensate from the inlet across the neutralizer toward the fluid outlet.

The outlet may be disposed at an end of a first tubular member extending from the upper portion of the condensate chamber. In addition, the exhaust conduit may include a sensor mount disposed on an exterior surface of the first tubular member, such that the sensor mount is configured to support one or more sensors. The exhaust conduit further may include one or more support ribs extending along an interior surface of the first tubular member, such that an upper end of the one or more support ribs is spaced a predefined distance from the outlet. Accordingly, a portion of the exhaust vent may extend within the first tubular member along the predefined distance and sits on the one or more support ribs.

Moreover, the inlet may be disposed at an end of a second tubular member extending laterally from the first tubular member. The second tubular member may extend in a direction perpendicular to the first tubular member. In addition, a lower portion of the second tubular member may be coupled to a lower portion of the first tubular member via a curved surface disposed within the interior of the condensate chamber. The curved surface may have an opening to provide fluid communication between the first and second tubular members and the interior of the condensate chamber. The upper portion and the lower portion of the condensate chamber may be removably coupled, such that the lower portion may have an upwardly extending lip sized and shaped to receive a lower edge of the upper portion therein.

The fluid outlet may be disposed at an end of a first tubular member extending laterally from the condensate chamber. Moreover, the first tubular member may be in fluid communication with a second tubular member extending from the first tubular member downwardly along an interior surface of the condensate chamber, such that a lower end of the second tubular member is spaced a predefined distance from a bottom surface of the condensate chamber defining an opening into the second tubular member. The second tubular member further may include an air hole vent configured to vent the interior of the condensate chamber to atmospheric pressure via the fluid outlet. In addition, the second tubular member may have a semi-circular cross-sectional area. Moreover, at least one ridge of the one or more ridges may be disposed adjacent to second tubular member, such that condensate flows over the at least one ridge through the opening into the second tubular member and out the fluid outlet.

At least one ridge of the one or more ridges may extend upwardly from a bottom surface of the lower portion of the condensate chamber. Additionally, at least another ridge of the one or more ridges may extend from the upper portion of the condensate chamber. An end of the at least another ridge of the one or more ridges may have a geometry sized and shaped to engage with a corresponding end of the at least one ridge of the one or more ridges. In addition, at least one ridge of the one or more ridges may have a curved shaped.

The service port may include a tubular member extending upwardly from the upper portion of the condensate member. The exhaust conduit further may include a lid configured to be removably coupled to the service port. For example, the service port may have a first threaded portion and the lid may have a second threaded portion configured to mate with the first threaded portion.

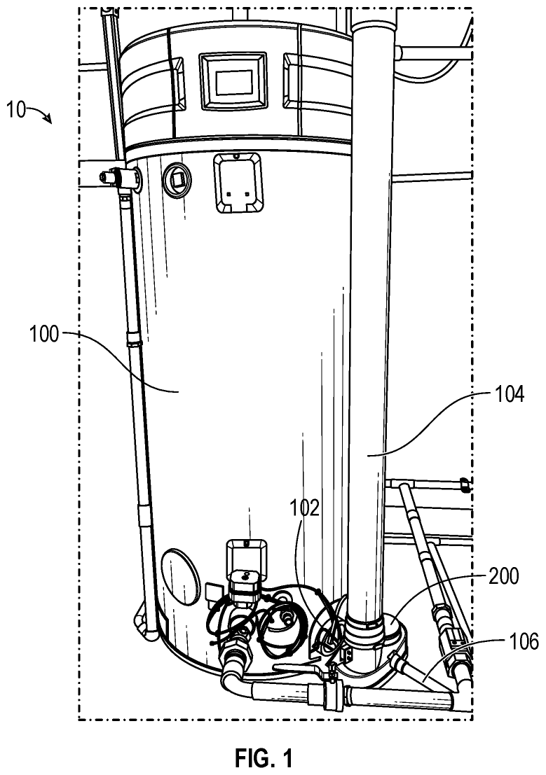

Referring now to FIG. 1, an exemplary system water heating system is provided. System 10 includes gas burning apparatus 100, e.g., a gas storage water heater, water heater, boiler, furnace, etc., having exhaust outlet 102 coupled to an exhaust conduit, e.g., exhaust tee 200, for expelling exhaust gases. Exhaust tee 200 is coupled to exhaust vent 104 for expelling exhaust gases, and to drain line 106 for draining condensate formed within exhaust tee 200. As described above, apparatus 100 may produce acidic condensate, which should be properly neutralized before draining via drain line 106. Accordingly, exhaust tee 200 includes a condensate chamber for holding a neutralizing agent therein, such that the acidic condensate is forced to flow across and be neutralized by the neutralizing agent prior to draining via drain line 106. For example, the neutralizing agent may be pelletized media or chips or fragments of a neutralizing mineral. The neutralizing agent may include lime, metal carbonate (e.g., calcite, sodium carbonate, or the like), metal oxide or hydroxide (e.g., magnesium oxide or hydroxide), or other neutralizing substance. As described in further detail below, exhaust tee 200 includes a service port which may be opened to provide access to the interior of exhaust tee 200 such that an operator may add or remove the neutralizing agent from the chamber of exhaust tee 200 and/or inspect the interior of the chamber of exhaust tee 200 to ensure proper neutralization of the acidic condensate.

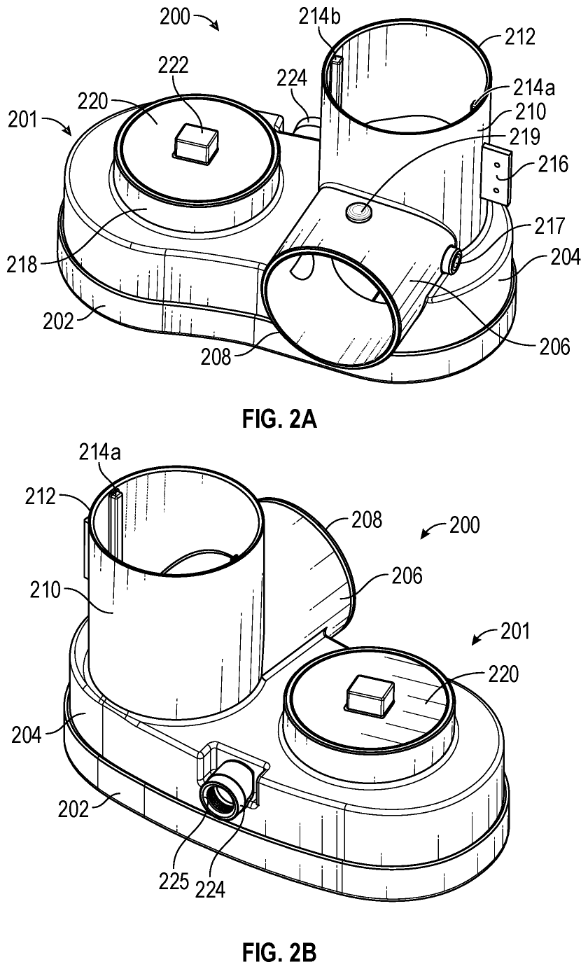

Referring now to FIGS. 2A to 2C, an exemplary exhaust tee is provided. Exhaust tee 200 includes lower portion 202 and upper portion 204, together defining condensate chamber 201 having an interior for holding the neutralizer, draining condensate, and exhausting gases. Condensate chamber 201 is configured to maintain a proper draft pressure, e.g., a negative pressure relative to the pressure in a combustion chamber, e.g., the combustion chamber of appliance 100. Lower portion 202 and upper portion 204 may be formed of any suitable material, such as a polymer material, e.g., polypropylene. In some embodiments, exhaust tee 200 may resist damage and, for example, accommodate at least 3969 PSI (e.g., when adding the average weight of an adult human and the weight of max vent length), and have a max yield stress of at least 4410 PSI, which is 10% below yielding.

Upper portion 204 includes intake member 206 having inlet 208, and exhaust member 210 having outlet 212. As shown in FIGS. 2A to 2C, intake member 206 and exhaust member 210 may have a tubular shape. Specifically, inlet 208 is sized and shaped to be coupled to exhaust outlet 102 of appliance 100, such that exhaust gases may be expelled from appliance 100 into intake member 206 of exhaust tee 200 via exhaust outlet 102 and inlet 208. Outlet 212 is sized and shaped to be coupled to exhaust vent 104 of system 10, such that exhaust gases may be expelled from system 10 via outlet 212 of exhaust tee 200 and exhaust vent 104.

For example, exhaust tee 200 may include one or more support ribs, e.g., ribs 214a and 214b, extending upwardly along an interior of exhaust member 210. The upper edge of the one or more support ribs may be disposed a predefined distance from outlet 212 of exhaust member 210, thereby providing a gap sized and shaped to receive a portion of the lower end of exhaust vent 104. For example, the upper edge of the one or more support ribs may be, e.g., 0.1 to 0.5 inches, or 0.15 to 0.4 inches, or 0.2 to 0.3 inches, or preferably 0.22 inches, from the edge of outlet 212, and ribs 214a and 214b may be separated by a distance of, e.g., 2 to 6 inches, 3 to 5 inches, 3.5 to 4.5 inches, 4 to 4.2 inches, or preferably 4.16 inches. Accordingly, when exhaust vent 104 is coupled to exhaust member 210, a portion of exhaust vent 104 extends within exhaust member 210 from outlet 212 along the predefined distance and sits on the one or more support ribs. The one or more support ribs assist in preventing the operator/installer from inserting exhaust vent 104 too far into exhaust member 210, which would prevent proper airflow and make it more difficult to remove exhaust vent 104 if collector service is required. The one or more support ribs may be evenly spaced apart within the exhaust member 210 to provide even support to exhaust vent 104. As will be understood by a person having ordinary skill in the art, although only two support ribs are shown in FIGS. 2A to 2C, less or more than two support ribs may be positioned within exhaust member 210, e.g., one, three, four, five, or more support ribs.

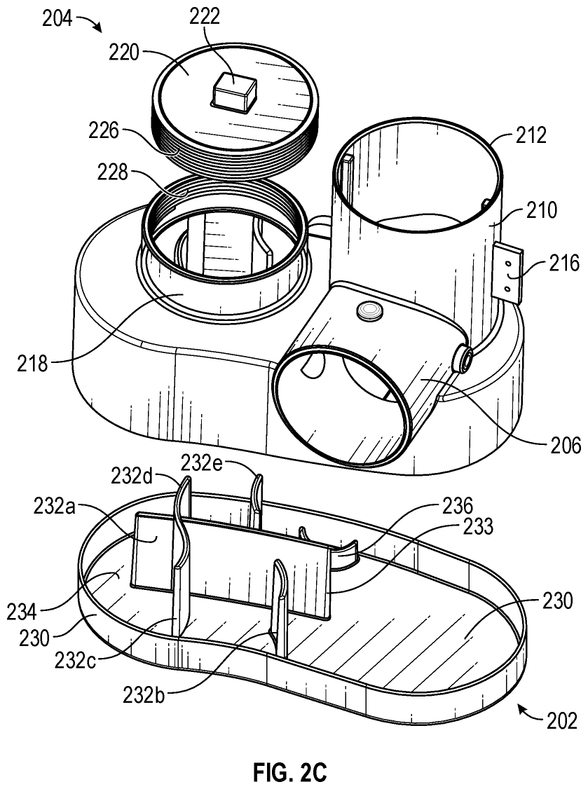

As shown in FIGS. 2A to 2C, exhaust member 210 may extend upwardly from an upper surface of upper portion 204, and intake member 206 may extend laterally from upper portion 204, e.g., laterally from at least a portion of the exterior surface of exhaust member 210. For example, intake member 206 may extend in a direction perpendicular to exhaust member 210. Accordingly, exhaust tee 200 may be disposed on a flat surface, e.g., the ground as shown in FIG. 1, such that intake member 206 extends laterally from exhaust tee 200 to be coupled to exhaust outlet 102 of appliance 100 and exhaust member 210 extends upwardly from exhaust tee 200 to be coupled to exhaust vent 104. At least a portion of intake member 206 and exhaust member 210 may be disposed within the interior of upper portion 204, as described in further detail below with reference to FIG. 3.

Referring again to FIGS. 2A to 2C, exhaust tee 200 may include mounting bracket 216, e.g., a sensor mount for securing a sensor to exhaust 200. For example, the sensor may be a temperature sensor, a pressure sensor, a pH sensor, etc. Alternatively, mounting bracket 216 may be used to secure exhaust tee 200 to appliance 100. Moreover, exhaust tee 200 may include sensor port 217 disposed on intake member 206, and sized and shaped to receive a temperature sensor for measuring the temperature within the interior of upper portion 204. Exhaust tee 200 further may include pressure port 219 disposed on intake member 206, which may be coupled to a pressure switch for measuring the pressure within the interior of upper portion 204.

Exhaust tee 200 includes service port 218 for providing access to the interior of condensate chamber 201. Accordingly, service port 218 may be an opening sized and shaped to permit at least an operator's hand therethrough, for example, to permit the operator to add neutralizing agent, e.g., neutralizing rocks, into the interior of condensate chamber 201, remove neutralizing agent from the interior of condensate chamber 201, confirm the amount of neutralizing agent within condensate chamber 201 is such that the neutralizing agent does enter fluid outlet 225, inspect the interior of condensate chamber 201 to see if there has been a build-up of scale that needs to be removed from condensate chamber 201, clean the interior of condensate chamber 201 if the scale build-up is excessive to provide better airflow through exhaust tee 200, etc., all without having to remove exhaust vent 104 from outlet 212 of exhaust tee 200 in order to perform any of the above operations, which is a current method for existing exhaust ducts with condensate neutralizing components. Moreover, service port 218 may include lid 220, which may include handle 222 to facilitate coupling of lid 220 to service port 218. Lid 220 forms an airtight seal when coupled to service port 218 in a closed state.

Service port 218 may be positioned directly on the upper surface of upper portion 204, or preferably, service port 218 may have an extended portion extending upwardly from the upper surface of upper portion 204 to reduce intrusion into the interior of condensate chamber 201, as shown in FIGS. 2A to 2C. For example, as shown in FIG. 2C, the interior surface of the extended portion of service port 218 may include threaded surface 228 configured to mate with threaded surface 226 on an exterior surface of lid 220. Alternatively, lid 220 may be a cap that covers the extended portion of service port 218, such that threaded surface 226 is on the interior surface of lid 220 and threaded surface 228 is on the exterior surface of the extended portion of service port 218. As will be understood by a person having ordinary skill in the art, although service port 218 is shown in FIGS. 2A to 2C as having a tubular shape, service port 218 may include other shapes and other closure mechanisms, e.g., a hinged door with a clasp and a sealing component, a sliding door with a handle and a sealing component, etc.

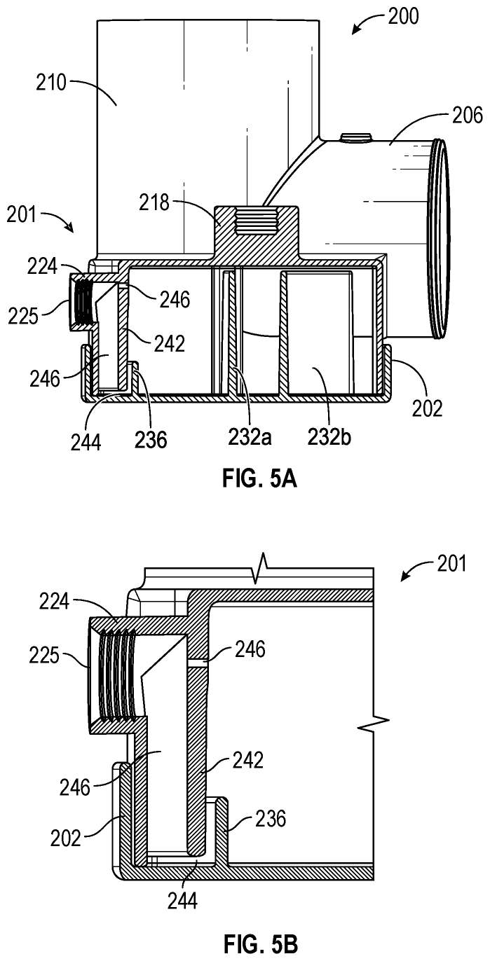

As shown in FIG. 2B, exhaust tee 200 may include fluid outlet 225 for draining condensate therethrough. Fluid outlet 225 is sized and shaped to be coupled to drain line 106, and is in fluid communication with the interior of condensate chamber 201, such that condensate pooled within reservoir 230 of lower portion 202 may be drained into drain line 106 via fluid outlet 225. As shown in FIG. 2B, fluid outlet 225 may include extended portion 224 extending laterally from upper portion 204 of exhaust tee 200. Extended portion 224 may have a tubular shape. Fluid outlet 225 may be spaced at a height above the bottom surface of lower portion 202 when lower portion 202 is coupled with upper portion 204, such that the condensate may accumulate within the interior of condensate chamber 201 before it exits via fluid outlet 225. Drainage of fluid via fluid outlet 225 is described in further detail below with reference to FIGS. 5A and 5B. Preferably, lower portion 202 and upper portion 204 are formed separately during manufacturing and coupled together.

Referring now to FIG. 3, the interior of lower portion 202 is described. As shown in FIG. 3, lower portion 202 may include lip 203 extending upwardly from the bottom surface of lower portion 202 along a perimeter of lower portion 202. Lip 203 is sized and shaped to receive a lower edge of upper portion 204, such that upper portion 204 and lower portion 202 form a close fit. For example, lip 203 may have a height of, e.g., 0.5 to 3 inches, or 0.6 to 2 inches, or 0.8 to 1.5 inches, or 0.9 to 1 inch, or preferably 1.06 inches. A sealing component, such as polyurethane, silicone, or other suitable heat-resistant adhesive materials, may be used to seal the connection between lower portion 202 and upper portion 204. Moreover, lip 203 forms at least a portion of reservoir 230 sized and shaped to receive a neutralizing agent, e.g., neutralizing rocks, therein. When upper portion 204 is coupled to lower portion 202, an amount of neutralizing agent may be added into the interior of condensate chamber 201, e.g., via service port 218, that exceeds the height of lip 203.

Lower portion 230 further may include one or more ridges, e.g., ridges 232a-232e, that extend upwardly from the bottom surface of lower portion 230, and are arranged to define channel 234 configured to direct condensate from intake member 206 and exhaust member 210 across the neutralizing agent toward fluid outlet 225. Ridges 232a-232e may be individual components, or in some embodiments, at least some ridges of ridges 232a-232e may be formed as a single integrated component. At least some ridges 232a-232e may have a curved shaped to guide fluid flow across channel 234. Ridges 232a-232e may have a height that extends from the bottom surface to the upper surface of the interior of condensate chamber 201 when lower portion 202 and upper portion 204 are coupled together. For example, the ridges may have a height of, e.g., 1 to 5 inches, or 1.5 to 4 inches, or 1.7 to 3.5 inches, or 2 to 3 inches, or preferably 2.75 inches.

As shown in FIG. 3, ridges 232a, 232c, 232d may be coupled together to form a t-shape, and are spaced away from the interior surface of upper portion 204 when upper portion 204 is coupled to lower portion 202, thereby defining channel 234 in the space between the outward facing edges of ridges 232a, 232c, 232d and the interior surface of upper portion 204. For example, ridge 232a may be positioned, e.g., 1 to 4 inches, or 2 to 3 inches, or preferably 2.37 inches from a front wall of upper portion 204, 2 to 5 inches, or 3 to 4 inches, or preferably 3.05 inches from a back wall of upper portion 204, and 0.5 to 3 inches, or 1 to 2 inches, or preferably 1.5 inches from a side wall of upper portion 204. Moreover, ridges 232b, 232e may be spaced away from ridge 232a, such that ridges 232b, 232e come in contact, or in close contact, with the interior surface of upper portion 204 when upper portion 204 is coupled to lower portion 202, thereby defining channel 234 between the inward facing edges of ridges 232b, 232e and ridge 232a. For example, ridge 232a may be positioned, e.g., 0.5 to 3 inches, or 1 to 2 inches, or preferably 1.14 inches from rib 232b, and 0.2 to 1.5 inches or 0.5 to 1 inch, or preferably 0.63 inches from rib 232e.

In addition, the outward facing edges of ridges 232b, 232e may be spaced away from lip 203 a distance sized to receive the lower edge of upper portion 204 therein. For example, rib 232c may be positioned, e.g., 0.5 to 2 inches, or 0.8 to 1.5 inches, or preferably 1.04 inches from the front wall of upper portion 204, 1 to 4 inches, or 2 to 3 inches, or preferably 2.83 inches from the side wall of upper portion 204, and 1 to 4 inches, or 2 to 3 inches, or preferably 2.89 inches from rib 232b, and rib 232d may be positioned, e.g., 0.5 to 3 inches, or 1 to 2 inches, or preferably 1.21 inches from the back wall of upper portion 204, 0.5 to 4 inches, or 1 to 3 inches, or preferably 2.28 inches from the side wall of upper portion 204, and 0.5 to 4 inches, or 1 to 3 inches, or preferably 2.02 inches from rib 232e.

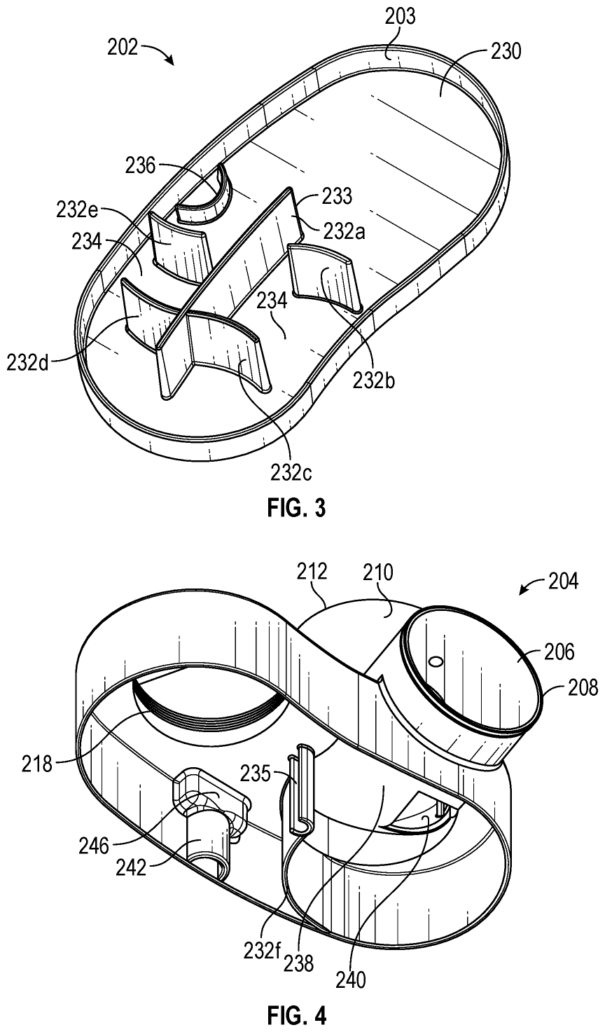

As will be understood by a person having ordinary skill in the art, ridges 232a-232e may have different shapes/curvatures than what is shown in FIG. 3 to define the channel to direct condensate from inlet 208 toward fluid outlet 225. An additional ridge, described in further detail below with reference to FIG. 4, may extend from inward facing edge 233 of ridge 232a toward lip 203 when upper portion 204 and lower portion 202 are coupled together to further define channel 234 from intake member 206 and exhaust member 210 to fluid outlet 225, such that condensate preferably only flows in one direction across channel 234 within reservoir 230.

Exhaust tee 200 further may include ridge 236 spaced away from lip 203 a distance sized to receive the lower edge of upper portion 204 therein. Ridge 236 may have a curved shaped corresponding to the curved shaped of the fluid column coupled to extended portion 224 of fluid outlet 225, as described in further detail below. Ridge 236 may extend upwardly from the bottom surface of lower portion 202, and may have a height selected to permit condensate to pool in reservoir 230 by a predetermined amount before the condensate flows over ridge 236 and into the fluid column for draining via fluid outlet 225. For example, the center of ridge 236 may be positioned 0.5 to 2 inches, or 0.7 to 1 inch, or preferably 0.93 inches from a back wall of lip 203, the edges of ridge 236 may be positioned, e.g., 0.1 to 1 inch, or 0.2 to 0.5 inches, or preferably 0.29 inches from the back wall of lip 203, the inside edges of ridge 236 may be positioned apart by, e.g., 0.5 to 3 inches, or 1 to 2 inches, or preferably 1.51 inches apart, and lip 203 may have a height of, e.g., 0.2 to 2 inches, or 0.5 to 1 inch, or preferably 0.75 inches.

Referring now to FIG. 4, an interior of upper portion 204 is described. As shown in FIG. 4, upper portion 204 may include ridge 232f extending from an interior surface of upper portion 204, and having edge 235. Edge 235 may be sized and shaped to engage with and/or receive edge 233 of ridge 232a when lower portion 202 and upper portion 204 are coupled together. For example, edge 235 may have a C shape sized to receive edge 233 therein. Ridge 232f may have a height that extends from the bottom surface to the upper surface of the interior of condensate chamber 201 when lower portion 202 and upper portion 204 are coupled together. Alternatively, ridge 232f may be formed as part of lower portion 202, and/or may be formed integrally with ridge 232a. In addition, ridge 232f may have a curved shaped corresponding with the curved profile of exhaust member 210.

As described above, at least a portion of intake member 206 and exhaust member 210 may be disposed within the interior of upper portion 204. As shown in FIG. 4, intake member 206 and exhaust member 210 may be coupled together via curved portion 238 to provide efficient flow of exhaust gases from inlet 206 through intake member 206, curved portion 238, exhaust member 210 to outlet 212, while minimizing undesirable pressure drops within the flow of the exhaust gas. Curved portion 238 extends within the interior of condensate chamber 201, and ridge 232f may have a curved shaped that corresponds with the curved shape of curved portion 238 so as not to interfere with curved portion 238. Moreover, curved portion 238 includes opening 240 to fluidicly couple intake member 206 with the interior of condensate chamber 201, and particularly reservoir 230, such that condensate produced within intake member 206, curved portion 238, and exhaust member 210 from exhaust gases flowing from inlet 206 toward outlet 212 may flow through opening 240 and into reservoir 230. Opening 240 may have any shape, such as circular, triangular, rectangular, etc. The acidic condensate may then flow across channel 234 defined by the arrangement of ridges 232a-232f and over ridge 236 into fluid column 242 for draining through drain line 106 via fluid outlet 225.

Referring now to FIGS. 5A and 5B, fluid column 242 is described. As shown in FIGS. 5A and 5B, fluid column 242 may extend along an interior surface of upper portion 204 defining a fluid flow path in fluid communication with fluid outlet 225. A lower edge of fluid column 242 may extend toward the lower edge of upper portion 204 and be spaced a predefined distance from the lower edge of upper portion 204, such that when upper portion 204 is coupled to lower portion 202, a gap is provided between the lower edge of fluid column 242 and the bottom surface of lower portion 202, thereby defining opening 244 into fluid column 242. Accordingly, neutralized condensate may flow over ridge 236, through opening 244, through the fluid flow path within fluid column 242, through extended portion 224, and into drain line 106 via fluid outlet 225. Fluid column 242 may have a curved shaped, e.g., a semi-circular cross-sectional area. Fluid column 242 may include air hole vent 246 configured to vent the interior of exhaust to atmospheric pressure via fluid outlet 225.

Modifications and variations of the methods and devices described herein will be obvious to those skilled in the art from the foregoing detailed description. Such modifications and variations are intended to come within the scope of the appended claims.

We claim:

1. An exhaust conduit for neutralizing condensate in exhaust gas from a gas storage water heater having an exhaust outlet as the exhaust gas is expelled via an exhaust vent, the exhaust conduit comprising:
an inlet configured to be coupled to the exhaust outlet;
an outlet configured to be coupled to the exhaust vent;
a condensate chamber having an interior in fluidic communication with the inlet and the outlet, the condensate chamber comprising a lower portion configured to receive a neutralizer and an upper portion comprising a service port configured to provide access to the lower portion of the condensate chamber in an open state;
a fluid outlet in fluidic communication with the condensate chamber; and
one or more ridges disposed in the chamber, the one or more ridges arranged to define a channel configured to direct condensate from the inlet across the neutralizer toward the fluid outlet.

2. The exhaust conduit of claim 1, wherein the outlet is disposed at an end of a first tubular member extending from the upper portion of the condensate chamber.

3. The exhaust conduit of claim 2, further comprising a sensor mount disposed on an exterior surface of the first tubular member, the sensor mount configured to support one or more sensors.

4. The exhaust conduit of claim 2, further comprising one or more support ribs extending along an interior surface of the first tubular member, an upper end of the one or more support ribs spaced a predefined distance from the outlet, such that a portion of the exhaust vent extends within the first tubular member along the predefined distance and sits on the one or more support ribs.

5. The exhaust conduit of claim 2, wherein the inlet is disposed at an end of a second tubular member extending laterally from the first tubular member.

6. The exhaust conduit of claim 5, wherein the second tubular member extends in a direction perpendicular to the first tubular member.

7. The exhaust conduit of claim 5, wherein a lower portion of the second tubular member is coupled to a lower portion of the first tubular member via a curved surface disposed within the interior of the condensate chamber, the curved surface comprising an opening to provide fluid communication between the first and second tubular members and the interior of the condensate chamber.

8. The exhaust conduit of claim 1, wherein the upper portion and the lower portion of the condensate chamber are removably coupled, the lower portion comprising an upwardly extending lip sized and shaped to receive a lower edge of the upper portion therein.

9. The exhaust conduit of claim 1, wherein the fluid outlet is disposed at an end of a first tubular member extending laterally from the condensate chamber, the first tubular member in fluid communication with a second tubular member extending from the first tubular member downwardly along an interior surface of the condensate chamber, a lower end of the second tubular member spaced a predefined distance from a bottom surface of the condensate chamber defining an opening into the second tubular member.

10. The exhaust conduit of claim 9, wherein the second tubular member comprises an air hole vent configured to vent the interior of the condensate chamber to atmospheric pressure via the fluid outlet.

11. The exhaust conduit of claim 9, wherein the second tubular member has a semi-circular cross-sectional area.

12. The exhaust conduit of claim 9, wherein at least one ridge of the one or more ridges is disposed adjacent to second tubular member, such that condensate flows over the at least one ridge through the opening into the second tubular member and out the fluid outlet.

13. The exhaust conduit of claim 1, wherein at least one ridge of the one or more ridges extends upwardly from a bottom surface of the lower portion of the condensate chamber.

14. The exhaust conduit of claim 13, wherein at least another ridge of the one or more ridges extends from the upper portion of the condensate chamber.

15. The exhaust conduit of claim 14, wherein an end of the at least another ridge of the one or more ridges comprises a geometry sized and shaped to engage with a corresponding end of the at least one ridge of the one or more ridges

16. The exhaust conduit of claim 1, wherein at least one ridge of the one or more ridges has a curved shaped.

17. The exhaust conduit of claim 1, wherein the service port comprises a tubular member extending upwardly from the upper portion of the condensate member.

18. The exhaust conduit of claim 1, further comprising a lid configured to be removably coupled to the service port.

19. The exhaust conduit of claim 18, wherein the service port comprises a first threaded portion and the lid comprises a second threaded portion configured to mate with the first threaded portion.

20. A gas storage water heater comprising:
an exhaust outlet; and
an exhaust conduit comprising:
an inlet configured to be coupled to the exhaust outlet;
an outlet configured to be coupled to an exhaust vent;
a condensate chamber having an interior in fluidic communication with the inlet and the outlet, the condensate chamber comprising a lower portion configured to receive a neutralizer and an upper portion comprising a service port configured to provide access to the lower portion of the condensate chamber in an open state;
a fluid outlet in fluidic communication with the condensate chamber; and
one or more ridges disposed in the chamber, the one or more ridges arranged to define a channel configured to direct condensate from the inlet across the neutralizer toward the fluid outlet.
